(19) United States
(12) Patent Application Publication
(10) Pub. No.: US 2026/0278649 A1
(43) Pub. Date: Sep. 17, 2026

(54) METHOD FOR MAXIMIZING TIME EFFICIENCY IN TRANSMITTING CAR DONATION FUNDS TO FUNDRAISING PLATFORM

(71) Applicant: Anthony R. Glenn, Laguna Beach, CA (US)

(72) Inventor: Anthony R. Glenn, Laguna Beach, CA (US)

(21) Appl. No.: 19/676,344

(22) Filed: May 13, 2026

Related U.S. Application Data
(63) Continuation-in-part of application No. 19/536,639, filed on Feb. 11, 2026.
(60) Provisional application No. 63/756,904, filed on Feb. 11, 2025.

(51) Int. Cl. G06Q 30/0279; G06Q 30/08; G06Q 50/18

(52) U.S. Cl. CPC G06Q 30/0279; G06Q 30/08; G06Q 50/18

(57) ABSTRACT

A method for submitting donation funds from a vehicle donation to an online fundraising platform. The method includes receiving a donation request for a vehicle comprising its condition and its identification number. The method further includes evaluating an estimated net proceeds of the donation, autonomously verifying and requesting signature of the title, and adjusting the estimated net proceeds of the donation based on an autonomous determination of the condition of the vehicle. The method further includes submitting a payment of the estimated net proceeds of the donation to the online fundraising platform, auctioning the vehicle through an auctioning platform, and receiving an auction payment from the auctioning platform.

### CROSS-REFERENCE TO OTHER APPLICATIONS

This application is a continuation-in-part and claims benefit of U.S. patent application Ser. No. 19/536,639 filed Feb. 11, 2026, which is a non-provisional and claims benefit of U.S. Provisional Application No. 63/756,904 filed Feb. 11, 2025, the specification of which are incorporated herein in their entirety by reference.

### FIELD OF THE INVENTION

The present invention is directed to methods for maximizing the time efficiency between receiving a vehicle donation and delivering the funds from the car donation to a fundraising platform.

### BACKGROUND OF THE INVENTION

When it comes to transmitting funds from vehicle (e.g., a car) donations to fundraising platforms, such as Kickstarter® or GoFundMe®, the issue has to do with funding and timing, the average fundraising campaign duration is 2-3 weeks. The average car donation process duration is 30+ days. For example, the campaign launches on day 1, the donor donates a vehicle online on day 2, campaign concludes on day 21. The process is concluded on day 30-effectively receiving sale proceeds from a donated car after the conclusion of the average campaign. Thus, there exists a present need for providing funds from car donations to fundraising platforms before their campaigns conclude.

### BRIEF SUMMARY OF THE INVENTION

It is an objective of the present invention to provide methods that allow for providing funds from car donations to fundraising platforms before their campaigns conclude, as specified in the independent claims. Embodiments of the invention are given in the dependent claims. Embodiments of the present invention can be freely combined with each other if they are not mutually exclusive.

The present invention features a method for submitting donation funds from a vehicle donation to an online fundraising platform. The method may comprise receiving a donation request for a vehicle comprising its condition and its identification number. The method may further comprise evaluating an estimated net proceeds of the donation, comprising an estimated value of the vehicle, acquiring the vehicle and a title associated with it, verifying an actual condition of the vehicle and adjusting the estimated net proceeds of the donation if need be, and verifying that the identification number matches the vehicle and the title associated with the vehicle. The method may further comprise submitting a payment of the estimated net proceeds of the donation to the online fundraising platform, auctioning the vehicle through an auctioning platform, and receiving an auction payment from the auctioning platform.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a flow chart of a method for submitting donation funds from a vehicle donation to an online fundraising platform of the present invention.

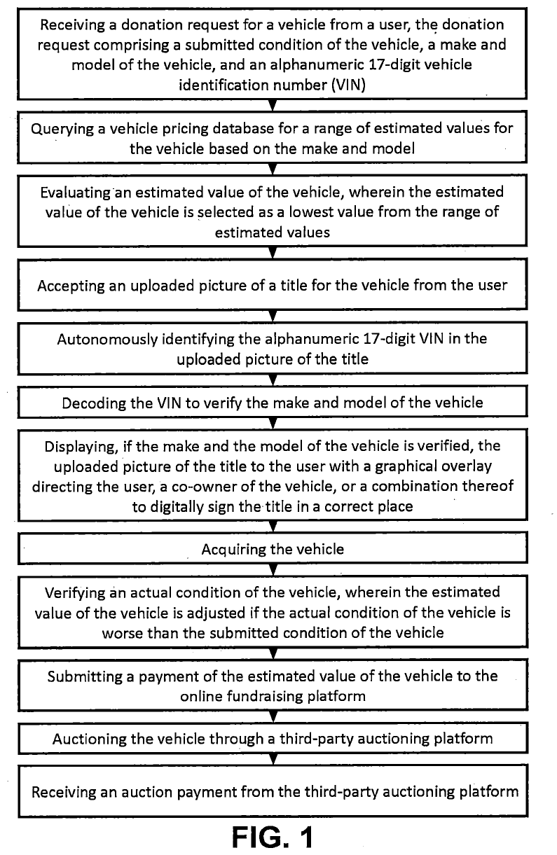

FIG. 2 shows a flow chart of a method for carrying out a follow-up payment to a donation source based on a surplus from the sales price based on the estimated price.

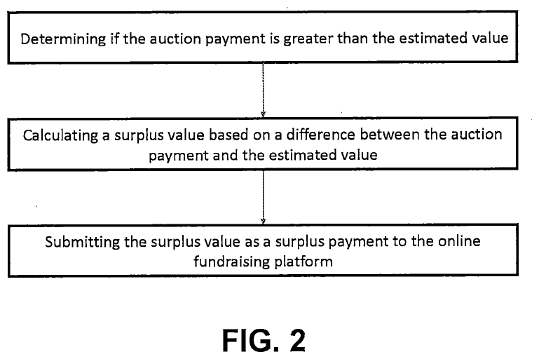

FIG. 3 shows a flow chart of a method for autonomously calculating a vehicle's condition and adjusting the estimated price accordingly.

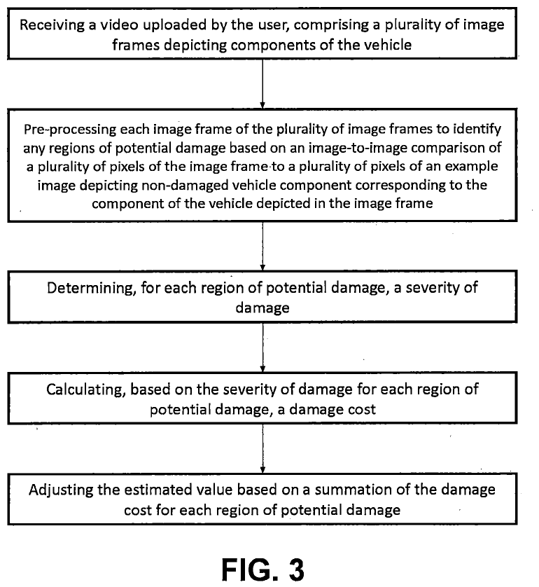

### DETAILED DESCRIPTION OF THE INVENTION

In some aspects, the techniques described herein relate to a method for submitting donation funds from a vehicle donation to an online fundraising platform, the method including: a. receiving a donation request for a vehicle from a user, the donation request including a submitted condition of the vehicle, a make and model of the vehicle, and an alphanumeric 17-digit vehicle identification number (VIN); b. querying a vehicle pricing database for a range of estimated values for the vehicle based on the make and model; c. evaluating an estimated net proceeds of the donation, comprising an estimated value of the vehicle, wherein the estimated value of the vehicle is selected as a lowest value from the range of estimated values; d. accepting an uploaded picture of a title for the vehicle from the user; e. autonomously identifying the alphanumeric 17-digit VIN in the uploaded picture of the title; f. decoding the VIN to verify the make and model of the vehicle; g. displaying, if the make and the model of the vehicle is verified, the uploaded picture of the title to the user with a graphical overlay directing the user, a co-owner of the vehicle, or a combination thereof to digitally sign the title in a correct place; h. acquiring the vehicle; i. verifying an actual condition of the vehicle, wherein the estimated net proceeds of the donation is adjusted if the actual condition of the vehicle is worse than the submitted condition of the vehicle; j. submitting a payment of the estimated net proceeds of the donation to the online fundraising platform; k. auctioning the vehicle through an auctioning platform; and l. receiving an auction payment from the auctioning platform.

In some aspects, the techniques described herein relate to a method further including: a. determining if the auction payment is greater than the estimated net proceeds of the donation; b. calculating a surplus value based on a difference between the auction payment and the estimated net proceeds of the donation; and c. submitting the surplus value as a surplus payment to the online fundraising platform.

In some aspects, the techniques described herein relate to a method further including extracting a nominal fee from the surplus payment.

In some aspects, the techniques described herein relate to a method further including adjusting the estimated net proceeds of the donation to account for auction expenses, towing expenses, and additional expenses.

In some aspects, the techniques described herein relate to a method, wherein verifying the actual condition of the vehicle includes: a. receiving a video uploaded by the user, including a plurality of image frames depicting components of the vehicle; b. pre-processing each image frame of the plurality of image frames to identify any regions of potential damage based on an image-to-image comparison of a plurality of pixels of the image frame to a plurality of pixels of an example image depicting non-damaged vehicle component corresponding to the component of the vehicle depicted in the image frame; c. determining, for each region of potential damage, a severity of damage; d. calculating, based on the severity of damage for each region of potential damage, a damage cost; and e. adjusting the estimated net proceeds of the donation based on a summation of the damage cost for each region of potential damage.

In some aspects, the techniques described herein relate to a method, wherein the components include doors, tires, odometer, steering wheel, dashboard, brakes, bumpers, lights, or a combination thereof.

The present invention features a method for submitting donation funds from a vehicle donation to an online fundraising platform. In some embodiments, the method may comprise receiving a donation request for a vehicle, the donation request comprising a submitted condition of the vehicle and an identification number. The method may further comprise evaluating an estimated net proceeds of the donation, comprising an estimated value of the vehicle. The estimated value of the vehicle may be selected as the lowest value from a range of estimated values. The method may further comprise acquiring the vehicle and a title associated with the vehicle. The method may further comprise verifying an actual condition of the vehicle. The estimated value of the vehicle may be adjusted if the actual condition of the vehicle is worse than the submitted condition of the vehicle. The method may further comprise verifying that the identification number matches the vehicle and the title associated with the vehicle. The method may further comprise submitting a payment of the estimated net proceeds of the donation to the online fundraising platform. The method may further comprise auctioning the vehicle through an auctioning platform. The method may further comprise receiving an auction payment from the auctioning platform. In short, the present method involves fronting a vehicle's value to the fundraising platform before actually receiving the payment, accepting a loss if the vehicle is sold under value, and donating the surplus if the car is sold over value.

In some embodiments, the method may further comprise determining if the auction payment is greater than the estimated value. The method may further comprise calculating a surplus value based on the difference between the auction payment and the estimated value. The method may further comprise submitting the surplus value as a surplus payment to the fundraising platform. The method may further comprise extracting a nominal fee from the surplus payment.

In some embodiments, the method may further comprise adjusting the estimated value to account for auction expenses, towing expenses, and additional expenses. In some embodiments, verifying that the identification number matches the vehicle and the title associated with the vehicle may comprise querying a vehicle identification number database with the identification number to confirm that the identification number matches the vehicle. In some embodiments, the method of the present invention may be executed on a computing system.

The present invention implements a solution that when the three following conditions are met, the donation management platform would advance the Estimated Net Proceeds to the charity/campaign being supported. The donation management platform (or its auction/tow partner) must have physical possession of the donated vehicle. The vehicle description and condition match the description in the donation process. The donation management platform (or its auction/tow partner) must have physical possession of the donated vehicle's clean (lien-free), executable certificate of title (aka Pink Slip). The estimated value of the vehicle is fronted to the fundraising platform as the vehicle is auctioned off.

In most cases, the donation management platform sells the vehicle for more than projected. In these cases, a second payment is issued for the final proceeds (final sale price, less initial payment, actual expenses & reserve fund set-aside fee of, for example, $49.00 if the final net proceeds figure exceeds, for example, $100).

The present invention is configured to adapt and automate the car donation process such that the process can fit into the average fundraising campaign duration of 2-3 weeks. The process relies on the following three criteria being met in order for a payment to be processed. 1) The user must have physical possession of the donated vehicle; 2) The vehicle description and condition match description in donation process; and 3) The user must have physical possession of the donated vehicles clean (lien-free), executable certificate of title (aka the pink slip). The technical features of the presently claimed invention allow for criteria 2 and 3 to be achieved in a timely manner such that the claimed process is achievable within a 2-3 week window. In most cases, the vehicle it sold for more than projected in the estimated value. In these cases, a second payment may be calculated and issued for the final proceeds.

The present invention features a method for processing a title of a vehicle. Donors may be asked to take a photo of the title to their proposed donation and upload it to the ‘Vehicle’ tab. The processor may execute computer instructions to ‘read’ (optical character recognition/OCR) all text in the image, which may comprise the alphanumeric 17-digit VIN number, recognize the state origin, confirm if a lienholder exists (or confirm properly released), document license plate, and see exactly how the title is currently held. Upon completion of the above, the system may return to the donor a copy of the title image with a graphical ‘overlay’ onto the image guiding the donor exactly how and where to sign the title before sending it in. This title processing method may confirm that the donor has the title. Furthermore, 17-digit VIN numbers are frequently mistyped by donors which may cause delays, and accurate VIN numbers may enable confirmation of the year, make, model, and (occasionally) trim information. Knowing the state origin is of great importance, and a missing or incorrect lienholder release can be a deal-stopper. Understanding how title is currently held is paramount in avoiding signing errors, a donor incorrectly signing their title may cause a minimum of a 45-day delay in processing. The title processing method may confirm the age of the vehicle enabling the present invention to determine if the mileage field needs to be completed (a frequent area for errors). This capability may avert a majority of issues typically faced, saving time and allowing the tight fundraising window to be accommodated for.

In some embodiments, the present invention implements one or more computerized processes. These computerized processes may be executed on a local device in wireless communication with a cloud server, entirely on a cloud server, or any other distribution of processes between any number of devices. For example, the submission of images/videos and user information may be collected on a user's local device, and then transmitted to a cloud server which takes care of the processing of user images/videos and user information, verification, payment processing and transfer, etc.

In some embodiments, determining the condition/severity of damage to various components of the vehicle may be different depending on the component. For example, the image of the odometer may be processed by scraping the mileage of the vehicle from the image and comparing it to a threshold representative of an expected lifespan of the make and model of the vehicle. Images of lights, mirrors, windshields, etc. may be processed by identifying cracks. Images of tires may be processed by identifying punctures, presence of tires, etc. Identification of these regions of damage may be determined based on a comparison to images of undamaged versions of the corresponding component and images of said corresponding component at various stages of damage. This may be carried out through the use of a machine learning model trained on the images of each component described above, configured to accept user images/videos as input and generate a damage assessment in terms of how it affects cost of the vehicle as output.

### EXAMPLE

The following is non-limiting example of the presently claimed invention:

The original donation of the vehicle is made and confirmed by the user. The car donation is then considered. An estimated range of values are gathered from a vehicle pricing database and the lowest of these is chosen as the estimated value of the vehicle. The title of the vehicle is then verified. The car owner takes a picture of the title to the vehicle on their mobile computing device and uploads it to the cloud server. The cloud computing system comprises computer-readable instructions for accepting an uploaded picture of a title for the vehicle from the car owner, identifying an alphanumeric 17-digit vehicle identification number (VIN) in the uploaded picture of the title, decoding the VIN to determine a make and a model of the vehicle, verifying that the make and the model of the vehicle match the decoded VIN, and displaying, if the make and the model of the vehicle is verified, the uploaded picture of the title to the car owner with a graphical overlay directing the car owner (or owners) to sign the title in a correct place. Once the title has been confirmed and signed, the donation can be made, the car can be picked up, and it can be brought to auction for sale.

The car owner implements a software application installed on a mobile computing device with camera capabilities. The software application guides the car owner to a video of the vehicle at various angles and of various components (e.g., the bumper, the engine, the odometer, the tires, etc.). This image data is submitted wirelessly from the mobile computing device to a cloud server. The cloud server comprises computer-readable instructions for receiving the video data, pre-processing each image frame of the video data to identify any regions of potential damage based on an image-to-image comparison of a plurality of pixels of the image frame to a plurality of pixels of an example image depicting a non-damaged corresponding region of a car, determining, for each region of potential damage, a severity of damage, calculating, based on the severity of damage for each region, a damage cost, and adjusting the estimated value based on the total damage cost of all regions of potential damage.

After being received, the vehicle status is evaluated by the auction, with an estimated value already established. The condition report is received from the auction. If the condition is reported to result in a lower estimated value for the vehicle than the original, then the original estimate is re-evaluated. If the condition is reported to result in a higher or equal estimated value, then the first payment can proceed. When the vehicle is received by the auction, a floor price is set. The first payment is sent to the designated cause online, using Automated Clearing House (ACH) payments to reduce fees. The payment is made in the name of the donor of the vehicle or on behalf of the donor. If the sale price at the auction ends up exceeding the estimated value, the user must wait until the payment is received and cleared, the excess is calculated, and a second payment is made towards the same cause, once again implementing ACH payments. If the sale price at the auction ends up less than the estimated value, this cost is deducted from the reserves.

In some embodiments, the present invention may implement one or more artificial intelligence (AI) models for its various computerized processes. For example, the present invention may implement a specialized AI model for calculating the valuation of the vehicle, the estimated net proceeds of the donation, etc. In some embodiments, the present invention may implement an AI model for scraping the VIN number from the image of the title. In some embodiments, the present invention may implement an AI model for scraping any relevant information from images of the title, the vehicle, etc. In some embodiments, relevant information of the vehicle, the title owner, or any other relevant information may be scraped from databases (e.g., DMV databases).

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from a 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C #, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. A method for submitting donation funds from a vehicle donation to an online fundraising platform, the method comprising:
a. receiving a donation request for a vehicle from a user, the donation request comprising a submitted condition of the vehicle, a make and model of the vehicle, and an alphanumeric 17-digit vehicle identification number (VIN);
b. querying a vehicle pricing database for a range of estimated values for the vehicle based on the make and model;
c. evaluating an estimated net proceeds of the donation, the estimated net proceeds of the donation comprising an estimated value of the vehicle, wherein the estimated value of the vehicle is selected as a lowest value from the range of estimated values;
d. accepting an uploaded picture of a title for the vehicle from the user;
e. autonomously identifying the alphanumeric 17-digit VIN in the uploaded picture of the title;
f. decoding the VIN to verify the make and model of the vehicle;
g. displaying, if the make and the model of the vehicle is verified, the uploaded picture of the title to the user with a graphical overlay directing the user, a co-owner of the vehicle, or a combination thereof to digitally sign the title in a correct place;
i. verifying an actual condition of the vehicle, wherein the estimated value of the vehicle is adjusted if the actual condition of the vehicle is worse than the submitted condition of the vehicle;
j. submitting a payment of the estimated net proceeds of the donation to the online fundraising platform;
k. auctioning the vehicle through an auctioning platform; and
l. receiving an auction payment from the auctioning platform.

2. The method of claim 1 further comprising:
a. determining if the auction payment is greater than the estimated net proceeds of the donation;
b. calculating a surplus value based on a difference between the auction payment and the estimated net proceeds of the donation; and
c. submitting the surplus value as a surplus payment to the online fundraising platform.

3. The method of claim 1 further comprising adjusting the estimated net proceeds of the donation to account for auction expenses, towing expenses, and additional expenses.

4. The method of claim 1, wherein verifying the actual condition of the vehicle comprises:
a. receiving a video uploaded by the user, comprising a plurality of image frames depicting components of the vehicle;
b. pre-processing each image frame of the plurality of image frames to identify any regions of potential damage based on an image-to-image comparison of a plurality of pixels of the image frame to a plurality of pixels of an example image depicting non-damaged vehicle component corresponding to the component of the vehicle depicted in the image frame;
c. determining, for each region of potential damage, a severity of damage;
d. calculating, based on the severity of damage for each region of potential damage, a damage cost; and
e. adjusting the estimated net proceeds of the donation based on a summation of the damage cost for each region of potential damage.

5. The method of claim 4, wherein the components comprise doors, tires, odometer, steering wheel, dashboard, brakes, bumpers, lights, or a combination thereof.
